(19) United States
(12) Patent Application Publication
(10) Pub. No.: US 2008/0147631 A1
(43) Pub. Date: Jun. 19, 2008

(54) METHOD AND SYSTEM FOR COLLECTING AND RETRIEVING INFORMATION FROM WEB SITES

(76) Inventors: Dean Leffingwell, Luisville, CO (US); Jeremie Miller, Cascade, IA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/610,936

(22) Filed: Dec. 14, 2006

(51) Int. Cl. G06F 17/30

(52) U.S. Cl. 707/5

(57) ABSTRACT

A method and system for collecting and retrieving Web pages is described. One embodiment acquires a set of Web pages; for each Web page in the set of Web pages, analyzes the Web page for data artifacts, classifies each data artifact on the Web page as one of a predetermined set of types, and indexes and organizes, in at least one data structure, each classified data artifact, each indexed and organized data artifact in the at least one data structure being associated with a subject, all indexed and organized data artifacts that are associated with a non-unique subject being associated with a single subject entry; receives a query indicating a particular subject to be searched; retrieves search results from the at least one data structure, the search results including a set of data artifacts associated with the particular subject; and displays at least some of the search results, the displayed data artifacts in the search results being grouped in accordance with their respective types, the displayed data artifacts in the search results within each type being listed in descending order of relevance to the particular subject.

### FIELD OF THE INVENTION

The present invention relates generally to information storage and retrieval systems. In particular, but not by way of limitation, the present invention relates to methods and systems for collecting and retrieving information from Web sites.

### BACKGROUND OF THE INVENTION

The Internet, in particular the portion known as the World Wide Web (the “Web”), has become a repository for an astronomical amount of information about a wide variety of subjects. As experienced Web users are aware, finding specific information of interest among the vast stores of available information can be challenging.

To address this need to find information on the Web, a number of Web search sites have been developed. Search sites such as GOOGLE employ various algorithms to rank Web pages according to their relevance to one or more search terms. Other search sites such as ZOOMINFO have emerged that focus on finding information about people and the organizations (e.g., companies) with which they are associated. To find specific information using a conventional search engine, the user either has to know enough details about the subject beforehand to focus the search or has to be willing to sort through a large number of Web pages one by one to locate the relevant information.

Some Web searches do not lend themselves well to a conventional search engine such as GOOGLE or ZOOMINFO. For example, a user might desire information about a person named Bob Smith whom the user met at a social function several weeks before. The user does not remember that the Bob Smith of interest lives in Nevada but does remember that he likes to fish. The user also knows that Bob Smith works closely with a colleague whose name the user cannot quite remember, but the user thinks he or she would recognize the colleague's name if he or she were to see it again. Using a conventional search engine to find information about this specific Bob Smith under these circumstances would be extremely difficult, especially since “Bob Smith” is a very common name and the user does not even know the state in which this particular Bob Smith lives. Moreover, the user cannot search for Web pages mentioning both Bob Smith and Smith's colleague because the user cannot remember the colleague's name.

Similar challenges can arise where the user seeks information from the Web about subjects other than people. For example, a user might desire information associated with a specific location, organization, hobby or interest, or other subject. Finding such information using a conventional search engine can be daunting, especially where the user's knowledge of the subject is sketchy or incomplete.

It is thus apparent that there is a need in the art for an improved method and system for collecting and retrieving information from Web sites.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a method and system for collecting and retrieving information from Web sites. One illustrative embodiment is a method for collecting and retrieving information from Web sites, comprising acquiring a set of Web pages; for each Web page in the set of Web pages, analyzing the Web page for data artifacts, classifying each data artifact on the Web page as one of a predetermined set of types, and indexing and organizing, in at least one data structure, each classified data artifact, each indexed and organized data artifact in the at least one data structure being associated with a subject, all indexed and organized data artifacts that are associated with a non-unique subject being associated with a single subject entry; receiving a query indicating a particular subject to be searched; retrieving search results from the at least one data structure, the search results including a set of data artifacts associated with the particular subject; and displaying at least some of the search results, the displayed data artifacts in the search results being grouped in accordance with their respective types, the displayed data artifacts in the search results within each type being listed in descending order of relevance to the particular subject.

Another illustrative embodiment is a system for collecting and retrieving information from Web sites, comprising a data acquisition subsystem configured to acquire a set of Web pages; an inference, classification, and indexing subsystem configured, for each Web page in the set of Web pages, to analyze the Web page for data artifacts, classify each data artifact on the Web page as one of a predetermined set of types, and index and organize, in at least one data structure, each classified data artifact, each indexed and organized data artifact in the at least one data structure being associated with a subject, all indexed and organized data artifacts that are associated with a non-unique subject being associated with a single subject entry; and a search subsystem configured to receive a query indicating a particular subject to be searched, retrieve search results from the at least one data structure, the search results including a set of data artifacts associated with the particular subject, and display at least some of the search results, the displayed data artifacts in the search results being grouped in accordance with their respective types, the displayed data artifacts in the search results within each type being listed in descending order of relevance to the particular subject.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1 is a functional block diagram of a system for collecting and retrieving information from Web sites in accordance with an illustrative embodiment of the invention;

FIGS. 2A and 2B are mock screenshots showing search results before and after triangulation, respectively, in accordance with an illustrative embodiment of the invention;

FIG. 2C is a mock screenshot showing additional kinds of search results in accordance with an illustrative embodiment of the invention;

FIG. 3 is a diagram illustrating an example of the focusing of search results (triangulation) in accordance with an illustrative embodiment of the invention;

FIG. 4 is a functional block diagram of time-based searching in accordance with an illustrative embodiment of the invention;

FIG. 5A is a process flow diagram of a process for classifying data artifacts discovered on Web pages in accordance with an illustrative embodiment of the invention;

FIG. 5B is a diagram showing the association of data artifacts with a single subject entry in the data structures when the subject is non-unique, in accordance with an illustrative embodiment of the invention;

FIG. 6 is a diagram of data importation and exportation in accordance with an illustrative embodiment of the invention;

FIG. 7 is a diagram of Web-based application programming interfaces (APIS) in accordance with an illustrative embodiment of the invention;

FIG. 8 is a diagram of a distributed search architecture in accordance with an illustrative embodiment of the invention;

FIG. 9 is a flowchart of a method for collecting information from Web sites in accordance with an illustrative embodiment of the invention;

FIG. 10 is a flowchart of a method for collecting and retrieving information from Web sites in accordance with another illustrative embodiment of the invention;

FIG. 11 is a flowchart of a method for collecting and retrieving information from Web sites in accordance with another illustrative embodiment of the invention;

FIG. 12 is a flowchart of a method for collecting and retrieving information from Web sites in accordance with yet another illustrative embodiment of the invention;

FIG. 13 is a flowchart of a method for associating a data artifact with a search subject in accordance with an illustrative embodiment of the invention;

FIG. 14 is a flowchart of a method for exporting search results in accordance with an illustrative embodiment of the invention;

FIG. 15 is a flowchart of a method for importing search queries in accordance with an illustrative embodiment of the invention;

FIG. 16 is a flowchart of a method for processing a request for information collected from Web sites in accordance with an illustrative embodiment of the invention; and

FIG. 17 is a flowchart of a method for obtaining information collected from Web sites in accordance with an illustrative embodiment of the invention.

### DETAILED DESCRIPTION

Searches of the World Wide Web (the “Web”) for information about a subject can be greatly enhanced by presenting to the user categorized, organized information items associated with the subject that have been gleaned from a comprehensive collection of Web pages.

In an illustrative embodiment of the invention, a set of Web pages is acquired. This set of Web pages may constitute the entire Web or a significant portion thereof at a particular point in time. For each page in the set of Web pages, the Web page is analyzed for the presence of one or more data artifacts. As used herein, a “data artifact” is an item of information found on a Web page. Each identified data artifact is classified as one of a predetermined set of types. Examples of types include, without limitation, a name of a person, a geographic location, an organization, a clipping, an item concerning someone's education, an identifier associated with a manner of electronically contacting a person, a hobby, an interest, a biography, or an item of miscellaneous information. In other embodiments, a variety of other data-artifact types can be defined as needed to fit a particular application.

Once a data artifact has been classified, it is indexed and organized in one or more data structures. Each indexed and organized data artifact is associated with a subject based on an analysis of relationships or likely relationships between that data artifact and the subject. Where a subject is non-unique, all indexed and organized data artifacts associated with the non-unique subject are associated with a single subject entry in the data structures. In some embodiments, the subject is a name of a person to enable the retrieval of information associated with a specified name. In general, however, a “subject” can be any kind of data item on which a search of the one or more data structures is based and with which a user might desire to find associated information. For example, any of the data-artifact types listed above can be treated as subjects in indexing and organizing the one or more data structures.

When a search query is received indicating a particular subject to be searched, a set of data artifacts associated with the particular subject is retrieved from the data structures. In some embodiments, all data artifacts associated with the specified subject are retrieved. To aid the user in viewing the search results, the data artifacts may be grouped on a display in accordance with their respective types and ranked, within each type, in order of their relevance to the subject. For example, the data artifacts estimated to be most relevant within a given data-artifact type can be listed first, the remaining data artifacts of that type being listed in descending order of relevance.

Once search results associated with the particular subject have been retrieved from the data structures and displayed, the search results can be narrowed in accordance with user input.

In one illustrative embodiment, the subject is a person's name. For example, a user might wish to search for someone named “Bob Smith.” This embodiment returns all data artifacts (e.g., locations, organizations, names of other people, etc.) associated with the name “Bob Smith,” the data artifacts of each type being grouped and displayed in a separate ranked list. In some embodiments, morphological variations of the subject name (e.g., “Robert Smith” or “Rob Smith”) are taken into account. Since there are many Bob Smiths in the world, the number of data artifacts returned is very large. However, by simply selecting a particular data artifact, the user can narrow the search results to, for example, (1) data artifacts found on Web pages containing the selected data artifact or (2) data artifacts found on Web pages that do not contain the selected data artifact. This allows the user to “triangulate” to a specific Bob Smith who resides in Mississippi and who works for a particular company, for example. If desired, the user can “click through” to a Web page on which a particular data artifact was found.

In other embodiments, the principles of the invention may be applied to a variety of other Web-search applications other than searching for information associated with a person's name. Though the examples in this Detailed Description often focus on applications in which the subject to be searched is a person's name, this is not intended in any way to limit the scope of the appended claims.

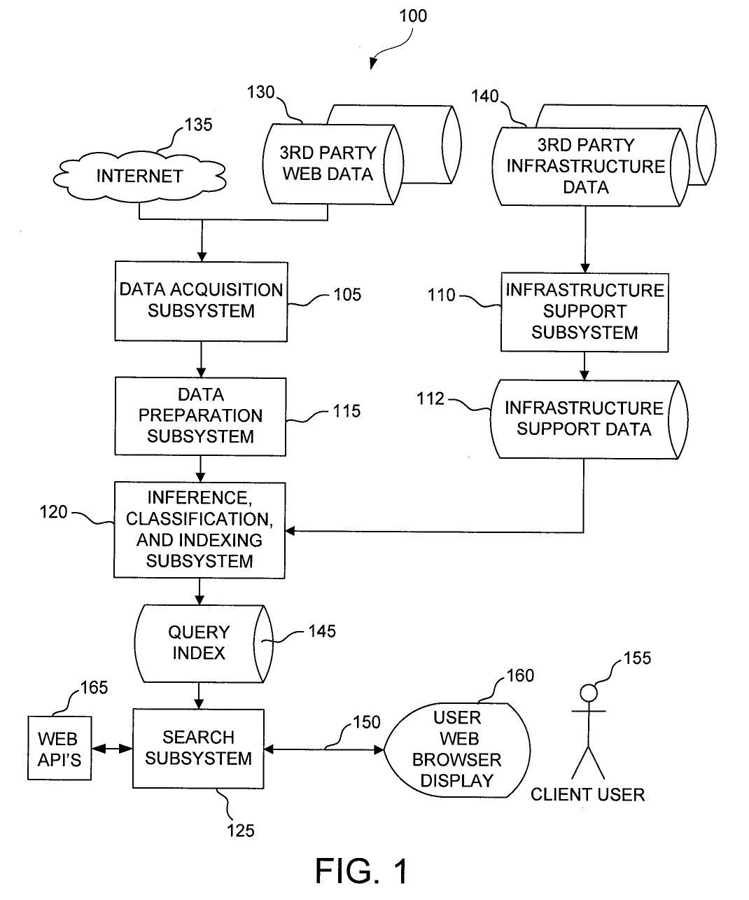

Referring now to the drawings, where like or similar elements are designated with identical reference numerals throughout the several views, and referring in particular to FIG. 1, it is a functional block diagram of a system 100 for collecting and retrieving information from Web sites in accordance with an illustrative embodiment of the invention. System 100 employs a number of techniques to deal with several distinct problems: collection and examination of large amounts of data collected from the entire Web (in a language-specific architecture); heuristic selection of data artifacts of interest (e.g., names, locations, organizations, etc.) from Web pages; preparation of large data structures to contain the data artifacts; preparation of large, search-optimized data structures containing the data artifacts, and rapid and efficient delivery of selected data artifacts to a requesting computer via a graphical user interface (GUI) or client-accessible Web application programming interfaces (APIs).

To address these distinct problems, the embodiment shown in FIG. 1 is organized into five major subsystems: data acquisition subsystem 105; infrastructure support subsystem 110; data preparation subsystem 115; inference, classification, and indexing (“ICI”) subsystem 120; and search subsystem 125. In other embodiments, one or more of these five major subsystems may be omitted, depending on the application. In various embodiments, the functional duties performed by these subsystems may be subdivided or combined in ways other than that shown in FIG. 1, and the subsystems may be called by different names. Such variations are considered to be within the scope of the claims. In general, the functionality of these subsystems may be implemented in software, firmware, hardware, or any combination thereof.

Data acquisition subsystem 105 collects the Web data used by system 100. In one embodiment, data acquisition subsystem 105 acquires third-party Web data 130 from one or more third-party data sources. In other embodiments, data acquisition subsystem 105 acquires Web data by “crawling” the Web via a connection with the Internet 135. In still other embodiments, data acquisition subsystem 105 acquires third-party Web data 130 from one or more third-party data sources and supplements the third-party Web data 130 by crawling the Web. Regardless of the data source, the collected Web pages are normalized and output in a standard format used by other subsystems of system 100. In some embodiments, data acquisition subsystem 105 employs data compression techniques to minimize the data volume collected.

Web pages may be represented in a wide variety of formats such as HyperText Markup Language (HTML), plain text, Portable Document Format (PDF), spreadsheets, word processing documents, etc. System 100 includes a variety of input processors (not shown in FIG. 1) that allow the system to process various data formats in a consistent manner.

Infrastructure support subsystem 110 examines other public and third-party infrastructure data collections 140 to construct lists (infrastructure support data 112) that are used by ICI subsystem 120. For example, infrastructure support subsystem 110 may collect public data for names and addresses in order to build lists of acceptable names of people, cities, states, or other defined types of data. The lists produced by infrastructure support subsystem 110 are used by ICI subsystem 120 to improve the accuracy of data-artifact classification. In some embodiments, infrastructure support subsystem 110 examines public databases on an occasional, intermittent basis to keep abreast of newer names, locations, or other types of data that may not currently reside in the lists it produces.

Data preparation subsystem 115 uses the collected Web data from data acquisition subsystem 105 to feed ICI subsystem 120. Data acquisition subsystem 105 attempts to collect Web data rapidly and efficiently. This can result in data structures that are not necessarily in the best format for subsequent processing by ICI subsystem 120. Data preparation subsystem 115 collects the data from data acquisition subsystem 105 and prepares data structures that are more efficient for subsequent processing.

In some embodiments, data preparation subsystem 115 removes a subset of the Web pages from the Web data collected by data acquisition subsystem 105 before the Web data is passed to ICI subsystem 120. In general, the subset of Web pages removed can be any data that is not intended to be processed by system 100. For example, the Web includes a large percentage of duplicate Web pages. In some embodiments, these duplicate Web pages are removed. As further examples, data preparation subsystem 115, in some embodiments, removes Web pages associated with pornography Web sites, Web pages containing spam, or both. Removing Web data such as duplicate pages, porn, and spam before subsequent processing improves the overall processing efficiency of system 100 by eliminating redundant or unnecessary work.

ICI subsystem 120, using the output of data preparation subsystem 115 and the lists prepared by infrastructure support subsystem 110, applies an extensive set of heuristics and rule-based grammar systems to identify, classify, rank, and store the data artifacts that are used by search subsystem 125. In one illustrative embodiment, ICI subsystem 120 analyzes the Web pages in the data received from data preparation subsystem 115 on a page-by-page basis to find and classify data artifacts. The classification of each data artifact as one of a predetermined set of types is discussed in greater detail in a later portion of this Detailed Description. ICI subsystem 120 indexes and organizes the classified data artifacts in one or more data structures. In the embodiment of FIG. 1, these data structures correspond to query index 145. In indexing and organizing the classified data artifacts, ICI subsystem 120 associates each classified data artifact with a subject to enable efficient retrieval of data artifacts associated with a particular search subject.

In some embodiments, ICI subsystem also assigns a local rank to the classified data artifacts on a page-by-page basis. That is, various ranking rules, specific to each type of data artifact, are applied to the discovered data artifacts on each Web page to estimate the relative rank or importance of those data artifact on the Web page. By way of illustration, the local ranking rules may take into consideration the position of the data artifact on the page (e.g., nearer to the top ranks higher than closer to the bottom), font size (e.g., larger font sizes rank higher than smaller font sizes), font style (e.g., bold-face text ranks higher than normal text), completeness of the artifact (e.g., more fully formed names, for example, rank higher than partial names), the likelihood that the data artifact is of a given type, or other indicators of relative importance.

Search subsystem 125 is the user-visible face of system 100. Search subsystem 125 handles user interface 150 and translates one or more user search queries into lookup processes.

When search subsystem 125 receives a query indicating a particular subject to be searched (a “search subject”), search subsystem 125 retrieves search results from the data structures (e.g., query index 145). The search results retrieved include some or all of the data artifacts associated with the search subject. In many cases, the collected information represents the amalgamated Web footprints of several subjects (e.g., people with the same name or a place name that exists in multiple physical locations) that share a common set of data artifacts. System 100 provides client user 155 with ways to narrow the search results to a particular instance of a subject (e.g., to a specific person called by the name searched or to a specific instance of a place name in a particular location). This aspect of system 100, referred to herein as “triangulation,” is discussed in greater detail in a later portion of this Detailed Description.

Upon collecting the relevant data artifacts for a search request, search subsystem 125 formats and displays the results by collaborating with the user's client-side browser (user Web-browser display 160) to display a nicely formatted set of data artifacts. In some embodiments, search subsystem 125 groups the data artifacts of each type together in the same portion of user Web-browser display 160. For example, each group of data artifacts of the same type may be displayed in its own panel or pane on the display. Within the displayed group of data artifacts of a given type, search subsystem 125 may also arrange the data artifacts in descending order of relevance to the search subject. In one embodiment, search subsystem 125 accomplishes this by assigning a global rank—a measure of relevance to the search subject—to each retrieved data artifact during processing of a query. In this illustrative embodiment, search subsystem 125 assigns the global rank to each retrieved data artifact based on an analysis of that data artifact's local rank and relationships among the retrieved data artifacts. As in the case of local ranking by ICI subsystem 120, various ranking algorithms are applied to the retrieved data artifacts to determine the final importance of each data artifact.

In this illustrative embodiment, global ranking begins by adding together all of the local ranks of the various instances of a given data artifact that is determined to be part of the search results. For example, if the name “John Doe” appears 13 times in the search results, system 100 begins the global ranking process by adding together all of the local ranks that were assigned to the respective occurrences of that name in the search results. System 100 augments the global ranking by taking into consideration specific features that may be particular to a data artifact. For example, the global ranking of an “associate” data artifact—a data artifact, other than the search subject, classified as a name of a person that is inferred to be associated with the search subject—is augmented by its physical proximity to the search subject on one or more Web pages. That is, a data artifact classified as a name of a person that appears closer to an occurrence of the search subject on the underlying Web pages is globally ranked higher than such a data artifact that is found farther away from an occurrence of the search subject. Other global ranking augmentations may be applied depending on the data-artifact type and the relationship of the data artifact to other data artifacts.

In some embodiments, system 100 also includes a set of Web application programming interfaces (APIs) 165 to enable third parties to access some or all of the features of system 100. These APIs are discussed in greater detail in a later portion of this Detailed Description.

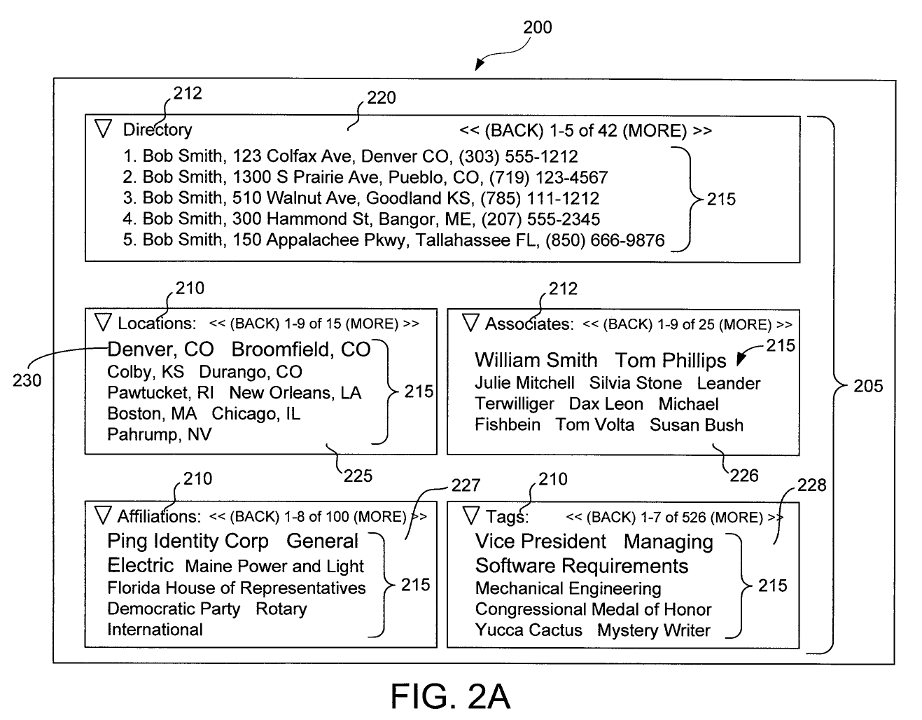

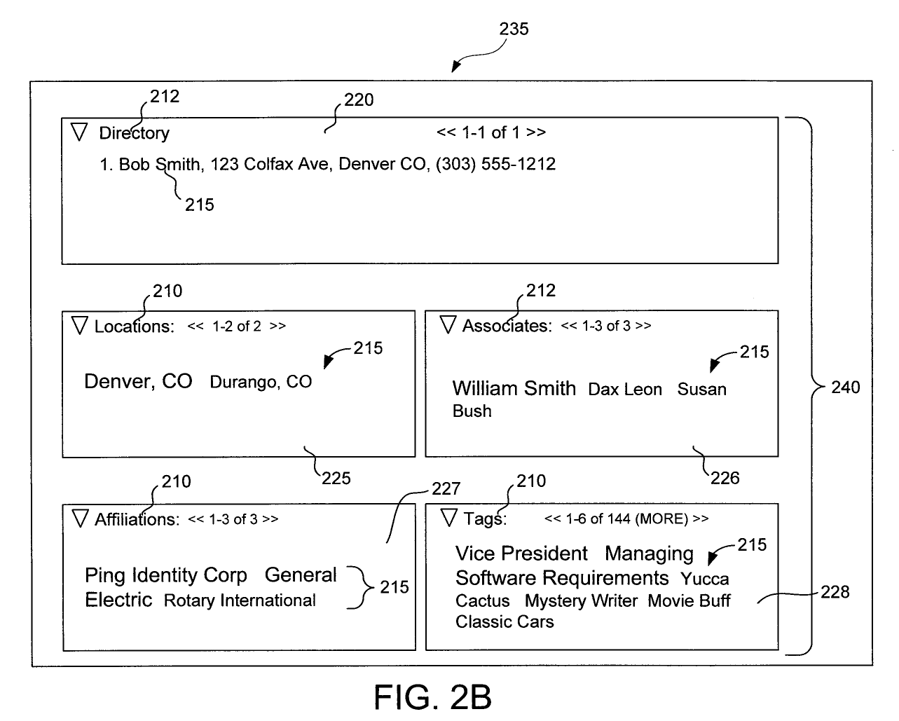

FIGS. 2A and 2B are mock screenshots showing search results before and after triangulation, respectively, in accordance with an illustrative embodiment of the invention. In FIG. 2A, mock screenshot 200 includes search results 205 grouped in accordance with the respective types 210 (or search-result categories 212, where the artifacts 215 are not assigned a type 210 by ICI subsystem 120) of the data artifacts 215. The various types 210 of data artifacts and search-result categories 212 are discussed in greater detail in a later portion of this Detailed Description. For clarity, most data artifacts 215 in FIGS. 2A and 2B have been labeled in groups rather than individually.

In FIG. 2A, the directory section 220 lists the first five of 42 occurrences of a search subject “Bob Smith,” and the location section 225 lists the first nine of 15 different locations associated with those occurrences of the search subject. In response to client user 155 selecting (e.g., clicking on) the specific location “Denver, Colo.” (230) in location section 225, search subsystem 125 limits search results 205 to those data artifacts 215 among the original set of search results 205 that are from Web pages mentioning the location Colorado. FIG. 2B shows a mock screenshot 235 containing the resulting triangulated search results 240.

FIG. 2C is a mock screenshot showing additional kinds of search results in accordance with an illustrative embodiment of the invention. For simplicity, only a few representative kinds of data artifacts 215 are shown in FIGS. 2A and 2B. Mock screenshot 245 in FIG. 2C includes two additional kinds of data artifacts 215: clippings and Uniform Resource Locators (URLs). In general, the number of different kinds of data artifacts 215 that search subsystem 125 displays depends on the particular embodiment.

As indicated in FIG. 2C, “clipping” is a data-artifact type 210 assigned by ICI subsystem 120 to clipping data artifacts 215. In this example, clippings section 250 contains a list of clippings associated with the search subject “Bob Smith.”

URLs section 255 contains a relevance-ranked list of URLs. Though they are data artifacts 215, URLs are not, in this illustrative embodiment, assigned a data-artifact type 210 during classification by ICI subsystem 120. The relevance-ranked list of URLs in URLs section 255 is a list of all of the various URLs that participated in the search for the subject “Bob Smith.” That is, the list includes the URLs of the Web pages from which the data artifacts 215 constituting the search results were obtained. It is advantageous to present the list of URLs in descending order of their relevance to the search subject. For example, the URLs can be prioritized in accordance with their information density in relation to the search subject.

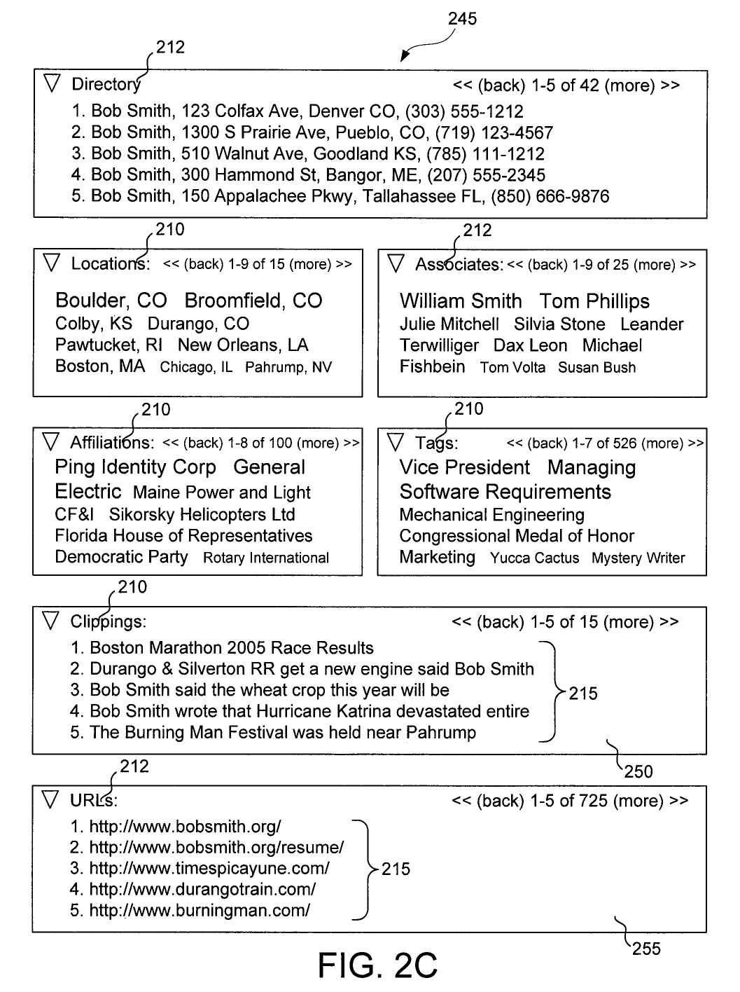

FIG. 3 is a diagram illustrating an additional example of triangulation in accordance with an illustrative embodiment of the invention. In this example, a client user 155 has submitted a query for the search subject “Bob Smith.” The top set of boxes in FIG. 3 represents some of the data artifacts 215 retrieved prior to triangulation. These initial data artifacts indicate that the name “Bob Smith” is likely to be associated with John Doe, David Rockefeller, and Willie Nelson; that the name “Bob Smith” is likely to be affiliated with the Republican Party, General Electric Co., and Chase Manhattan Bank; and that Nelson Rockefeller has written something (a “clipping”) about someone named Bob Smith.

In the example of FIG. 3, client user 155 subsequently selects a particular data artifact 305 (“Republican”). By selecting this particular data artifact 305, client user 155 is telling system 100 to filter the search results to include only data artifacts 215 among the original search results that originated from Web pages containing the particular data artifact 305. The bottom boxes in FIG. 3 represent some of the data artifacts 215 remaining in the search results after triangulation. The resulting filtered set of data artifacts 215 are then globally ranked and displayed as explained above. In general, there is no practical limit, other than the obvious limitation of filtering out every data artifact 215, to the number of filters that client user 155 can apply to a search. That is, triangulation can be repeated for multiple selected data artifacts 215.

In cases where a query yields excessive results, it may be difficult to find a specific instance of a search subject because the relevant data artifacts 215 are buried in too much data. For example, the data artifacts 215 associated with Microsoft Chairman Bill Gates are so numerous that they overpower and effectively hide those associated with a less-well-known Bill Gates who lives in Kansas. To address this problem, system 100, in some embodiments, includes a different form of triangulation in which a Boolean “NOT” function excludes, from the original search results, data artifacts 215 that originated from Web pages containing a particular data artifact selected by client user 155. In the “Bill Gates” example just mentioned, client user 155 could search for a “Bill Gates” who is NOT affiliated with Microsoft, which would eliminate a number of irrelevant data artifacts 215 from the search results.

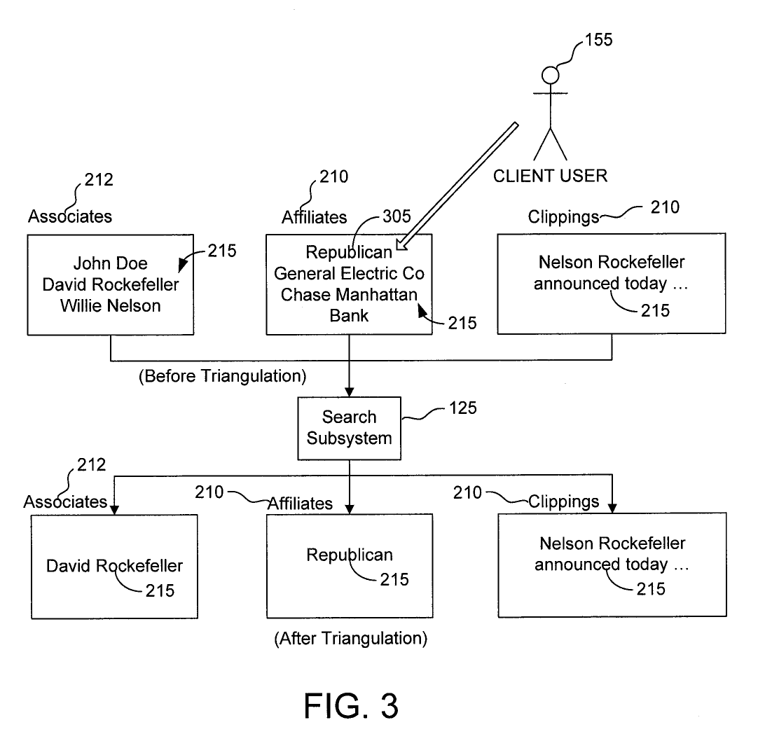

FIG. 4 is a functional block diagram of time-based searching in accordance with an illustrative embodiment of the invention. In this embodiment, system 100 periodically archives the data structures produced by ICI subsystem 120 (e.g., query index 145 in FIG. 1). For example, system 100 may archive the data structures on a daily, weekly, monthly, or annual basis, depending on the particular application. In FIG. 4, current query index 405 is the most recent query index. Previously archived query indexes 410 represent earlier snapshots of the processed Web data corresponding to earlier periods. This gives client user 415 the ability to search for a subject with respect to a specific period of time specified in the search query. For example, a search such as “John Doe circa 2003” submitted to search subsystem 420 may return dramatically different results to user Web-browser display 425 than a search for “John Doe circa 2006” because it is likely that affiliations, hobbies, and other associated data artifacts 215 will have evolved over time.

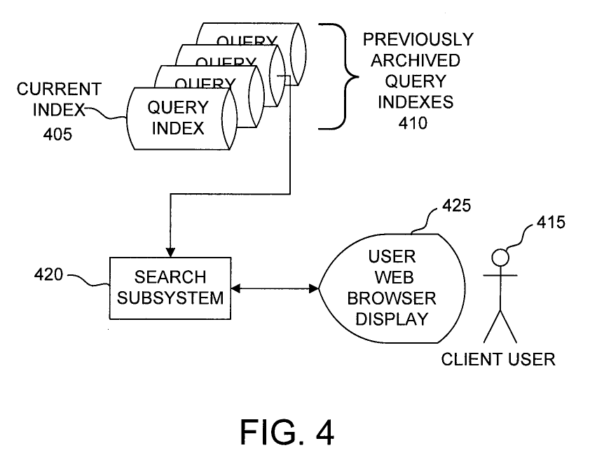

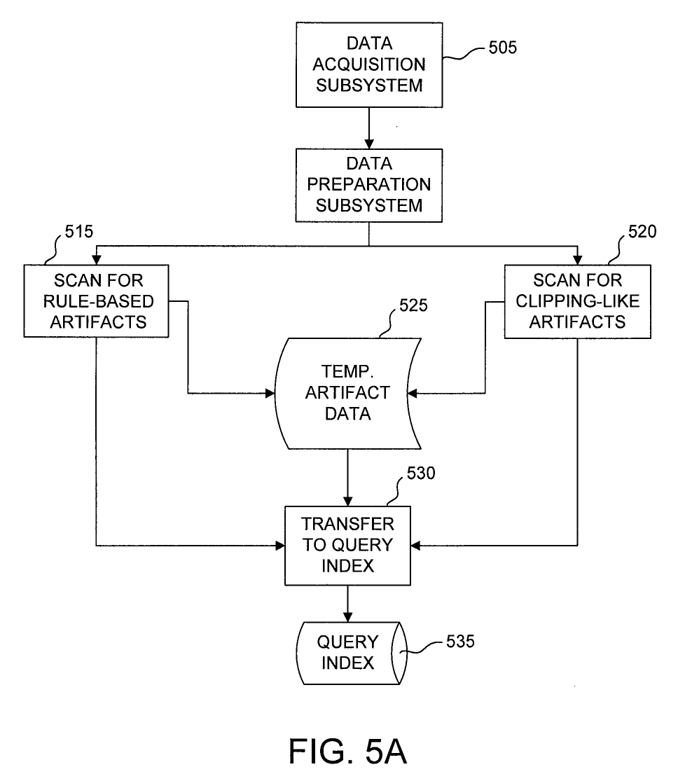

FIG. 5A is a process flow diagram of a process for classifying data artifacts discovered on Web pages in accordance with an illustrative embodiment of the invention. Classification of data artifacts 215 can be implemented in a variety of ways. The embodiment discussed in connection with FIG. 5A is merely one representative example. In this embodiment, classification of data artifacts 215 proceeds in stages. First, a Web page is analyzed to identify one or more data artifacts 215. Second, each identified data artifact 215 is classified as one of a predetermined set of types 210. Third, the classified data artifacts 215 are indexed and organized, by subject, in one or more data structures.

In some embodiments, the Web page is first decomposed into smaller units of data before being analyzed for data artifacts 215. For example, the Web page may be decomposed into “strings,” a contiguous block of text such as a sentence or paragraph bounded by predetermined Web-page delimiters. As a first approximation, a string is simply a sentence or paragraph as viewed on the original Web page. That is, all Web-page definition elements such as HTML tags, etc., have been removed by data acquisition subsystem 505, and the user-visible text is retained. Experiments have shown that the string concept produces natural units of work to classify. As the strings are defined, certain metadata features about the string such as its position on the Web page, its “style” (e.g., fonts, text features, etc.) are determined and become part of the overall classification of data artifacts 215 later on.

Discovery and classification of data artifacts 215 in Blocks 515 and 520 is largely based on the application of rule-based grammar detection elements. In one embodiment, discovery and classification of artifacts 215 in Blocks 515 and 520 is based on a set of context-free grammar rules. This approach avoids the complexity associated with full natural-language processing. For example, a name of a person is discovered by examining a portion of the Web page (e.g., a string) and applying a series of rules carefully constructed to detect the likely appearance of a name. A simple example of a first-order rule is “two contiguous words, each of which begins with an initial capital letter.” This rule can be combined with other rules and a list of recognized names produced by infrastructure support subsystem 110 to classify reliably a data artifact 215 as a name of a person. Analogous rules tailored to the characteristics of each particular data-artifact type 210 and, where applicable, lists produced by infrastructure support subsystem 110 are used to identify other types of data artifacts 215.

Once an artifact has been discovered and classified, it is stored temporarily (Block 525) until ICI subsystem 120 has indexed and organized it in query index 535 (Block 530). For example, the classified data artifact 215 may be stored in random-access memory (RAM) temporarily while other portions of a string or Web page are being examined.

Discovery and classification of data artifacts 215 can yield either a unique result or an overlapped result. A typical unique result is the determination that a data artifact 215 is, for example, a name of a person. Once the classification is made, the same portion of the Web page is not, in this embodiment, additionally classified as another data-artifact type (e.g., a location). On the other hand, once all the data artifacts 215 have been discovered in a portion of the Web page (e.g., a string), it might be the case that some or all of that portion of the Web page is also a clipping or other clipping-like data artifact. It is not unusual for certain data artifacts 215 (typically, a name of a person) to exist inside another data artifact 215 such as a clipping or a biography. ICI subsystem 120 can be designed to handle such overlapping cases as part of its normal duties.

Classification of a data artifact 215 is rarely a simple choice. System 100 is designed to confront discovered data artifacts 215 which may, in fact, appear likely to be any of several different and distinct types 210. For example, a data artifact 215 might be a name of a person, or it might be location. To address this kind of situation, determination of a data-artifact type 210 may include a probabilistic ranking. For example, ICI subsystem 120 might determine that a particular data artifact 215 has about a 60 percent chance of being a name and a 30 percent chance of being a location. Once various probabilistic ranking rules (part of the rules for each data-artifact type 210) have been applied for each potential data-artifact type 210, system 100 selects the data-artifact type 210 based on the highest probabilistic ranking among the various types 210.

The final work product of ICI subsystem 120 is one or more data structures that place the various discovered data artifacts 215 into a high-speed query index 535 that is optimized for efficient, high-speed searching in response to user queries. In one embodiment, at least one data structure contains an entry for each of a set of subjects. Associated and grouped together with each subject, in this embodiment, is a group of pointers that point to the actual data artifacts 215 stored in one or more separate data structures. The one or more data structures containing indexed pointers to data artifacts 215 may be replicated for each kind of subject to be searched, each such data structure being organized around the applicable type of subject (name of a person, location, organization, etc.) to looked up in response to a search query.

One of the challenges in indexing and organizing unstructured data gleaned from Web sites is that of disambiguation. Disambiguation refers to the process of determining with which unique instance of a non-unique subject a particular data artifact 215 is associated. For example, if there are 2000 different people with the name “Bob Smith” mentioned on the Web, associating a geographic location such as “Chicago, Ill.” with a specific Bob Smith is a disambiguation of that location data artifact 215. In some cases, such disambiguation is difficult or even impossible due to a lack of information. In an illustrative embodiment, disambiguation is not attempted during the indexing and organizing of data artifacts 215 by ICI subsystem 120. Instead, disambiguation is postponed until a user invokes the triangulation features of system 100 to focus the search results. This is explained further in connection with FIG. 5B.

FIG. 5B is a diagram showing the association of data artifacts with a single subject entry in the data structures when the subject is non-unique, in accordance with an illustrative embodiment of the invention. Though multiple instances of a subject might exist on the Web (e.g., multiple people with the same name—“Bob Smith”), this embodiment associates with a single subject entry all data artifacts 215 that are associated with such a non-unique subject. In associating data artifacts 215 with a single subject entry, morphological variations of the non-unique subject may be taken into account. For example, in a situation in which there are 2000 Bob Smiths on the Web, all data artifacts 215 associated with all of the various Bob Smiths are associated, in the data structures of system 100, with a single subject entry for “Bob Smith” and its morphological variations such as “Robert Smith,” “Rob Smith,” variations that include a middle name or initial, and so forth.

In FIG. 5B, Web data 540 includes three different Bob Smiths (545, 550, and 555), each having its own associated information (556, 557, 558). In practice, the associations between the three Bob Smiths and their respective information indicated in FIG. 5B might not be at all apparent from the unstructured data found on various Web pages. In this embodiment, ICI subsystem 120 does not attempt to disambiguate information 556, 557, and 558 as this information is identified and classified as various data artifacts 215. After ICI subsystem 120 has processed Web data 540, the data artifacts 215 corresponding to information 556, 557, and 558 are all associated with a single “Bob Smith” subject entry 560 in data structure 565. Search subsystem 125 can then assist with disambiguation via its triangulation capabilities, as described above.

Several representative data-artifact types 210 and search-result categories 212 will now be described in greater detail. As mentioned above, any of the various data-artifact types 210 can be treated as a subject in building query index 535 and in retrieving search results. The following descriptions are based on an embodiment in which a subject is a name of a person, but the same principles apply to other embodiments in which the search subject is a different type 210 of data artifact 215 or in which a user may select from among multiple available types of search subjects when submitting a query.

Directory. In some embodiments, system 100 includes a “directory” search-result category 212 and corresponding display area (panel) within the displayed search results (see, e.g., FIGS. 2A and 2B) for displaying name artifacts 215 that are associated with the search subject. In effect, the user can thumb through a directory of information of selected people by simply entering the name of the person of interest. Regardless of the number of returned data artifacts 215, the directory-results panel (see 220 in FIGS. 2A and 2B) lists all returned data artifacts 215 that in some sense match the search subject. These could include, for example, data artifacts 215 classified as a name of a person that, taking into account morphological variations, correspond to the search subject. In some embodiments, associated addresses and phone numbers are also included with the names in the directory-results panel.

Location. Where available, system 100 uses third-party sources and the Web pages themselves to extract and present location data associated with a search subject (see, e.g., 225 in FIGS. 2A and 2B). Examples of location data artifacts 215 include, without limitation, a complete street address, city, state, postal code, and country; a geographical or place name such as Yellowstone Park or Cherry Creek Mall; and a Standard Metropolitan Statistical Area (SMSA) such as Aguadilla or Puerto Rico.

Associate. Associates are data artifacts 215, other than the search subject itself, that are classified as a name of a person and that are likely to be associated with the indicated search subject (see, e.g., 226 in FIGS. 2A and 2B). In one embodiment, associates are returned as a search-result category 212 despite the absence of an “associate” data-artifact type 210 in ICI subsystem 120 as ICI subsystem 120 builds query index 535. Instead, in this embodiment, search subsystem 125 determines that a particular data artifact 215 classified as a name of a person is likely to be associated with the search subject during the processing of the search query. Search subsystem 125 can do so by considering the relationship between the particular data artifact 215 and the search subject on the Web pages that have been analyzed.

For example, a search for “John F. Kennedy” reveals “Jackie Kennedy” as an associate because the Web pages that contain the John Kennedy name may contain a Jackie Kennedy name entry on the same Web page, and system 100 has determined (correctly) that the two names are somehow related. Conversely, searching for “Jackie Kennedy” would reveal that “John F. Kennedy” is an associate.

Affiliation. Affiliations are represented as data artifacts 215 that are likely to be associated with the indicated search subject and that are likely to be a company or other organization with which the search subject is associated (see, e.g., 227 in FIGS. 2A and 2B). For example, a search for “John Kennedy” reveals “Democrat” as an affiliation because the pages that contain the John Kennedy name may contain a Democrat entry on the same Web page, and the invention has determined (correctly) that the Democratic Party is an organization with which John Kennedy is associated. Affiliations encompass a large variety of relationships and include, without limitation, companies, organizations, churches, special interest groups, political parties, and many other types of organizations.

Clippings. Clippings are Web-page selections of indeterminate length representing things that have been written by or about the search subject (see, e.g., FIGS. 2C and 3). For example, a data artifact 215 containing a phrase similar to “Patrick Henry said . . . ” is illustrative of a clipping and could be classified as such by ICI subsystem 120. Clippings represent a general category of unstructured information. More specific types 210 of unstructured information include, for example, biographies and education (an information item concerning a person's education).

URLs. Some embodiments of the invention discover, rank, and display a hyperlink to every Web page that potentially contains information of interest about a search subject (see, e.g., FIG. 2C). In one embodiment, these URLs are not assigned a data-artifact type 210 by ICI subsystem 120 during classification. Rather, they are data artifacts 215 that are displayed as a search-result category 212 in response to a query. In this embodiment, the URLs are simply a list of Web pages that participated in the final search results. These URLs are presented to the user for immediate click-through to the specific URL of interest. URLs may be accompanied by a short summary for ease of review and referral to the user. URLs may also be ranked and displayed in order of their relevance to the search subject, as explained above. Techniques for ranking URLs include frequency of use on a Web page, style of name presentation, proximity to the top of the page, and other characteristics.

Education. ICI subsystem 120 analyzes Web pages for a subject in order to determine, where feasible, the educational background of that subject. In some embodiments, search subsystem 125 displays data artifacts classified as “education clippings” in a dedicated pane. These education clippings may be derived via natural language processing that determines that a sentence about a subject (even if only referred to by first or last name, a pronoun, etc.) contains educational information about that subject.

Tags. System 100 discovers, ranks, and displays miscellaneous information about a search subject as a “tag” data artifact 215 (see, e.g., 228 in FIGS. 2A and 2B). Tags represent an important method for discovering things about a subject that otherwise would not be strictly classifiable as one of the standard data-artifact types 210. Experiments have shown that there is a wealth of miscellaneous and unpredictable information that nevertheless yields useful discriminators when one is searching a particular subject. For example, a search for the subject “Thomas Cech” would yield a tag data artifact 215 for Dr. Cech's Nobel Prize, a data item that would not have fit into any of the other data-artifact types 210. In identifying tags, system 100 may apply tailored ranking techniques to strike a balance between useful tag information and extraneous tag-like information that need not appear in the final search results.

Identifiers. System 100 may also discover, classify, and rank identifier data associated with a manner of electronically contacting a person. Such identifiers include, without limitation, e-mail addresses, instant-messaging user IDs, voice-over-Internet-protocol (VoIP) identifiers, phone numbers, and so forth.

Hobbies and Interests. To the extent that they are present in Web data, system 100 may also discover and rank hobbies and other interests that characterize a subject. This may be accomplished, for example, via a fuzzy match of Web-page text associated with the subject against a database of hobby and interest keywords and phrases obtained from infrastructure support subsystem 110.

Biographies. System 100 may also discover and present biographical data in a search-result pane whenever it can discovered about a search subject. The biographical data is clipping-like information that is extracted based on rules designed to identify such biographical data.

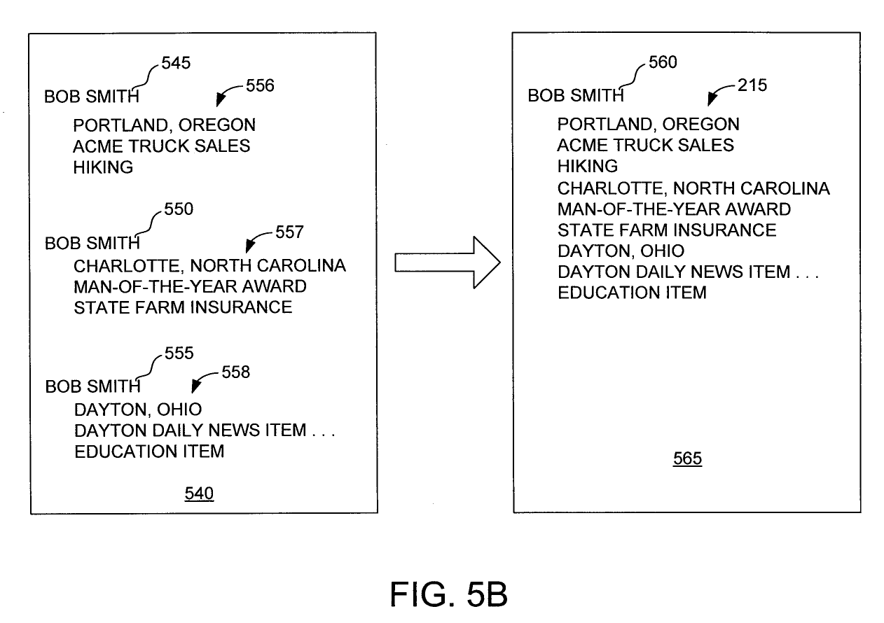

FIG. 6 is a diagram of data importation and exportation in accordance with an illustrative embodiment of the invention. In some cases, a client user 155 might wish to export the search results for further processing. In some embodiments, the invention provides a simple selection of export options to allow the client user 155 to export selected search queries, search results, or both (605) to a network destination specified by client user 155.

In some embodiments, the invention provides the ability to import one or more search queries 610 to search subsystem 125.

Similarly, users, particularly businesses, might want to submit their own lists of subjects (search data 615 in FIG. 6) to system 100 to obtain sets of search results associated with the respective subjects (e.g., names of people) on a given list. Then, using the data-exportation feature, a business can export specific data artifacts 215 for further processing. For example, a business might want to import a list of names and retrieve all of the hobbies of associated with the people on the list to support a targeted mailing. In some embodiments, system 100 provides a standard Web wizard to guide the importation of a user-supplied list to system 100.

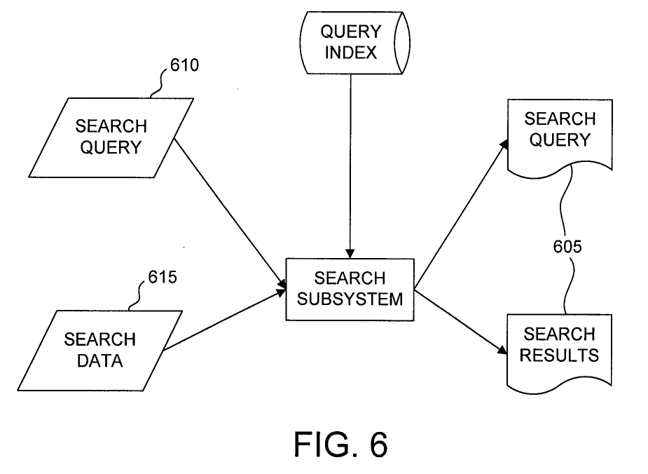

FIG. 7 is a diagram of Web-based application programming interfaces (APIs) in accordance with an illustrative embodiment of the invention. In general, the API set included in this embodiment is offered to allow third-party users 705 to construct simple programmatic interfaces to system 100 within their own applications to harness the power of system 100 for their own user-defined purposes. In this embodiment, the invention is fully available as a “people search” engine to interested third parties, especially businesses. As such, this embodiment includes APIs 710 and accompanying documentation to enable third parties 705 to use all or portions of its search capabilities. In one version of this embodiment, all system features are available via the Web APIs, including the import/export features discussed in connection with FIG. 6.

The APIs of this illustrative embodiment closely follow the task structure offered for a user-driven interactive search. That is, programmatic interfaces are offered to allow the third party 705 to present a sequence of search request atoms and connectors of arbitrary complexity. Triangulation APIs allow the third-party 705 to select specific data-artifact types 210 and data artifacts 215 for subsequent narrowing of the search results. Additional APIs allow the third party 705 to summon an import wizard to import query lists for a search. Export APIs allow the third party 705 to request the creation of simple text files containing search query requests, search results, or both.

Some versions of the foregoing embodiment may also include built-in safeguards that constrain the uses of the APIs to forestall excessive data mining and similar activities.

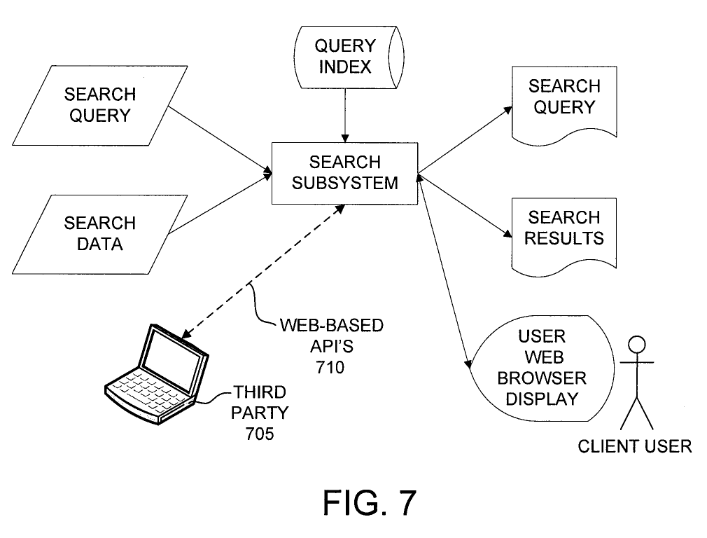

FIG. 8 is a diagram of a distributed search architecture 800 in accordance with an illustrative embodiment of the invention. To offer a rapid response to requests from a client computer 805 associated with a client user 810, search subsystem 125, in this embodiment, is designed to be distributed over multiple servers 815 and search routers 820 and to use distributed versions of the query index 825 built by ICI subsystem 120. To keep up with the work load of an ever-changing Web, ICI subsystem 120 may also be designed to be distributed over multiple servers to take advantage of parallel processing techniques.

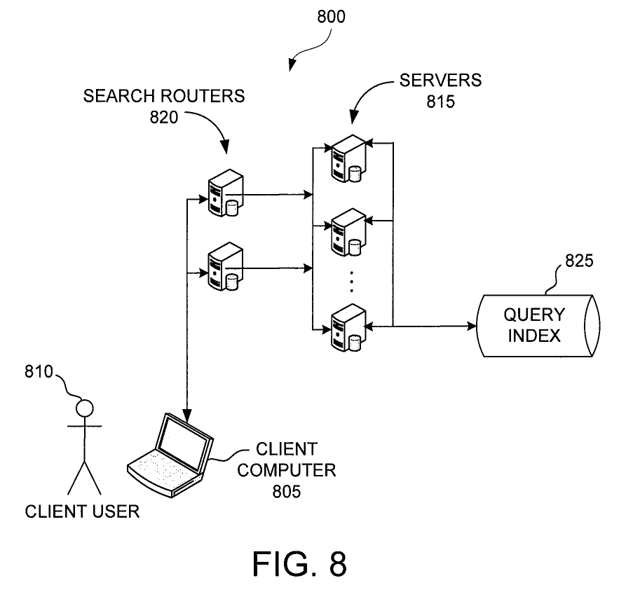

FIG. 9 is a flowchart of a method for collecting information from Web sites in accordance with an illustrative embodiment of the invention. At 905, data acquisition subsystem 105 acquires a collection of Web pages as explained above. For each Web page in the collection of Web pages, Blocks 910, 915, and 920 are performed. At 910, ICI subsystem 120 analyzes the Web page for one or more data artifacts 215. ICI subsystem 120, at 915, classifies each discovered data artifact 215 as one of a predetermined set of types 210. At 920, ICI subsystem 120 indexes and organizes each classified data artifact 215, associating each classified data artifact 215 with a subject. If there are no more Web pages to process at 925, the process terminates at 930.

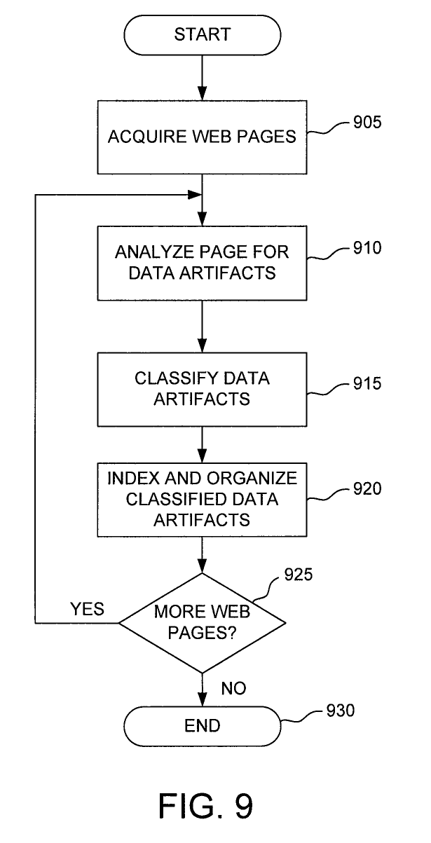

FIG. 10 is a flowchart of a method for collecting and retrieving information from Web sites in accordance with another illustrative embodiment of the invention. In this embodiment, the method proceeds as described in connection with FIG. 9 through Block 925. At 1005, search subsystem 125 receives a query from a client user 155 indicating a particular subject to be searched. At 1010, search subsystem 125 retrieves search results from query index 145, the search results including a set of data artifacts 215 associated with the particular subject. If the particular subject is not found in query index 145, search subsystem 125 outputs a suitable message to client user 155 indicating that no search results were found. If search results were found at 1010, search subsystem 125 displays at least some of the search results at 1015. As described above, search subsystem 125 may group the data artifacts 215 in the search results by their respective types 210 and display the data artifacts 215 within each type 210 in descending order of relevance to the particular subject based on a global ranking system. At 1020, the process terminates.

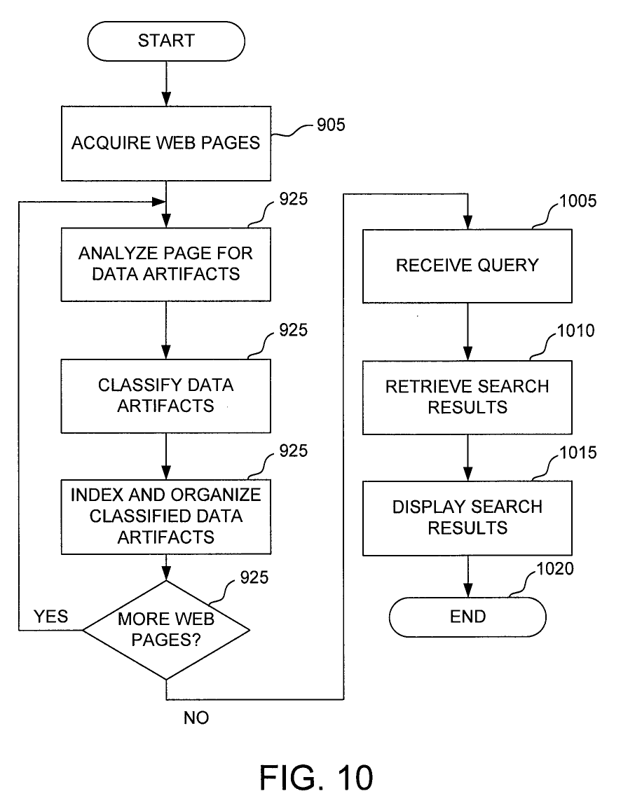

FIG. 11 is a flowchart of a method for collecting and retrieving information from Web sites in accordance with another illustrative embodiment of the invention. In this embodiment, the method proceeds as in FIG. 10 through Block 1015. At 1105, search subsystem 125 limits the search results to data artifacts 215 from Web pages that contain a particular data artifact 215 selected by client user 155 from among the original search results. Search subsystem 125 can perform this triangulation process in serial or parallel fashion for multiple selected data artifacts 215, the effect of the selection of multiple data artifacts 215 being a cumulative Boolean “AND” function. At 1110, the process terminates.

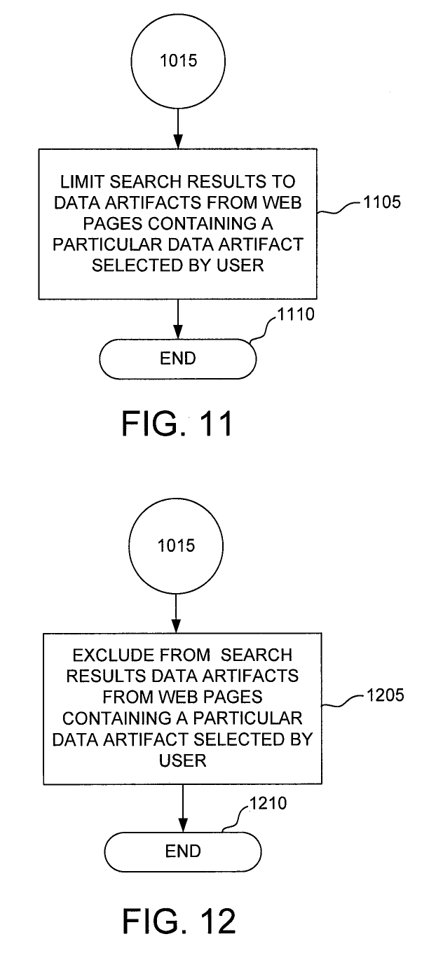

FIG. 12 is a flowchart of a method for collecting and retrieving information from Web sites in accordance with yet another illustrative embodiment of the invention. In this embodiment, the method proceeds as in FIG. 10 through Block 1015. At 1205, search subsystem 125 excludes from the search results data artifacts 215 from Web pages that contain a particular data artifact 215 selected by client user 155 from among the original search results. Search subsystem 125 can perform this triangulation operation in serial or parallel fashion for multiple selected data artifacts 215, the effect of the selection of multiple data artifacts 215 being a cumulative Boolean “NOT” function. At 1210, the process terminates.

In some embodiments, a user may select between the two triangulation modes described above prior to or in conjunction with selecting a particular data artifact 215.

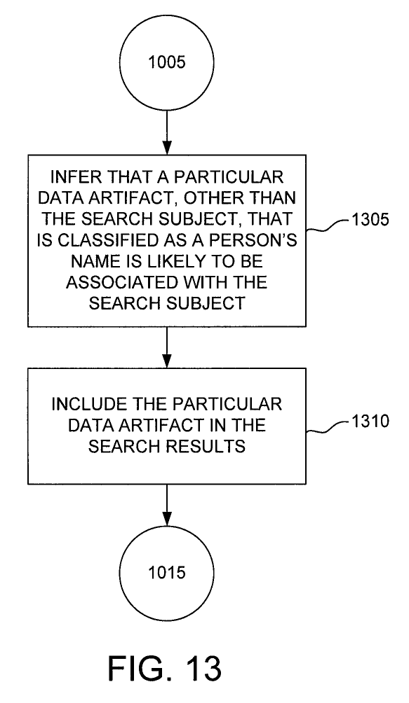

FIG. 13 is a flowchart of a method for associating a data artifact with a search subject in accordance with an illustrative embodiment of the invention. As explained above, in some embodiments of the invention, not all search-results output by search subsystem 125 correspond directly to data-artifact types 210 assigned by ICI subsystem 120 during the classification process. For example, associates-names of people likely to be associated with a subject-are determined by search subsystem 125 during the processing of a query in these embodiments. FIG. 13 shows a method that can be applied in conjunction with the retrieving of search results at Block 1010 in FIG. 10.

At 1305, search subsystem 125 infers that a particular data artifact 215, other than the search subject itself, that is classified as a person's name is likely to be associated with the search subject. At 1310, this particular data artifact 215 is included in the search results that are output by search subsystem 125 at Block 1015 in FIG. 10. For example, such a data artifact 215 can be displayed in a ranked list of “associates” in an associates pane (see, e.g., 226 in FIGS. 2A and 2B). As explained above, the inference at 1305 can be based on the joint occurrence of the search subject and the particular data artifact 215 on the same Web page, the proximity of the two names on that Web page, or other factors.

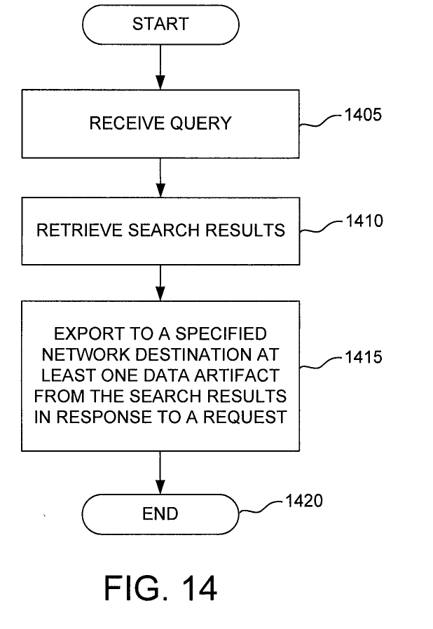

FIG. 14 is a flowchart of a method for exporting search results in accordance with an illustrative embodiment of the invention. At 1405, search subsystem 125 receives a query from a client user 155 indicating a particular subject to be searched. At 1410, search subsystem 125 retrieves search results from query index 145, the search results including a set of data artifacts 215 associated with the particular subject. At 1415, search subsystem 125 exports, to a specified network destination, at least one data artifact 215 from the search results in response to a request from the client user 155. In some embodiments, search subsystem 125 can output a search query itself in addition to or instead of one or more data artifacts 215 from the search results. At 1420, the process terminates.

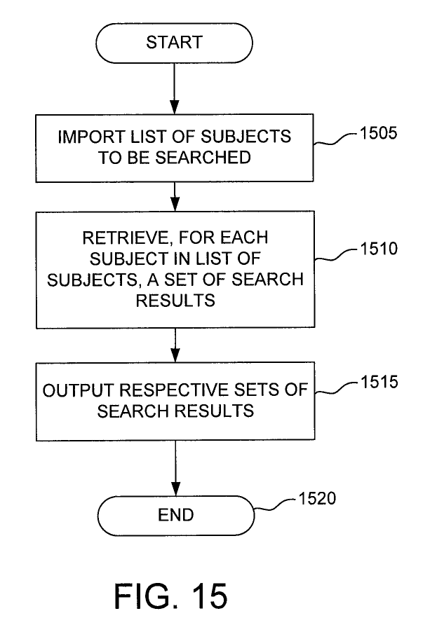

FIG. 15 is a flowchart of a method for importing search queries in accordance with an illustrative embodiment of the invention. At 1505, search subsystem 125 imports, from a client user 155, a list of subjects to be searched. At 1510, search subsystem 125 retrieves, for each subject in the list of subjects, a set of search results for that subject. Each set of search results includes a set of data artifacts 215 associated with the corresponding subject. At 1515, search subsystem 125 outputs the sets of search results associated with the respective subjects in the list of subjects. The process terminates at 1520.

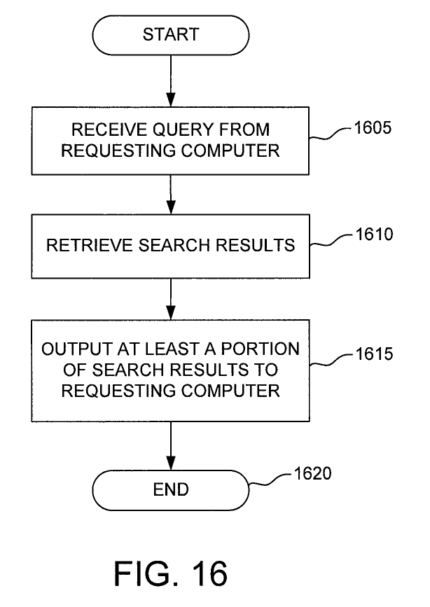

FIG. 16 is a flowchart of a method for processing a request for information collected from Web sites in accordance with an illustrative embodiment of the invention. At 1605, search subsystem 125 receives, from a requesting computer (e.g., a client computer associated with a client user 155), a search query indicating a particular subject to be searched. At 1610, search subsystem retrieves, from data structures such as query index 145, search results including a set of data artifacts 215 associated with the particular subject. At 1615, search subsystem 125 outputs, to the requesting computer, at least a portion of the search results retrieved at 1610. The output can be, for example, displayed search results on user Web-browser display 160, one or more exported files or data structures, or both. At 1620, the process terminates.

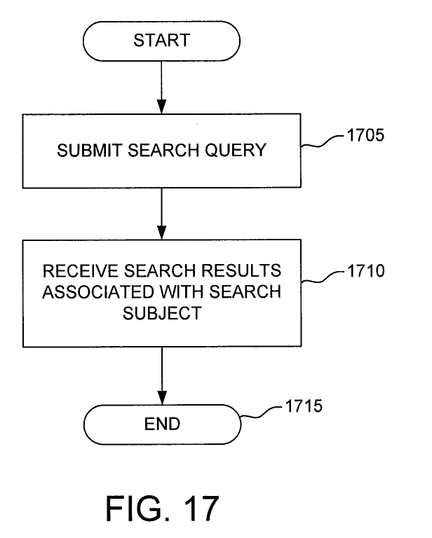

FIG. 17 is a flowchart of a method for obtaining information collected from Web sites in accordance with an illustrative embodiment of the invention. At 1705, a client user 155 submits, to search subsystem 125 over a network such as the Internet, a search query indicating a particular subject to be searched. At 1710, client user 155 receives search results from search subsystem 125, the search results including a set of data artifacts 215 associated with the particular subject. At 1715, the process terminates.

In conclusion, the present invention provides, among other things, a method and system for collecting and retrieving information from Web sites. Those skilled in the art can readily recognize that numerous variations and substitutions may be made in the invention, its use and its configuration to achieve substantially the same results as achieved by the embodiments described herein. Accordingly, there is no intention to limit the invention to the disclosed illustrative forms. Many variations, modifications, and alternative constructions fall within the scope and spirit of the disclosed invention as expressed in the claims.

What is claimed is:

1. A method for collecting and retrieving information from Web sites, the method comprising:
acquiring a set of Web pages;
for each Web page in the set of Web pages:
analyzing the Web page for data artifacts;
classifying each data artifact on the Web page as one of a predetermined set of types; and
indexing and organizing in at least one data structure each classified data artifact, each indexed and organized data artifact in the at least one data structure being associated with a subject, all indexed and organized data artifacts that are associated with a non-unique subject being associated with a single subject entry;
receiving a query indicating a particular subject to be searched;
retrieving search results from the at least one data structure, the search results including a set of data artifacts associated with the particular subject; and
displaying at least some of the search results, the displayed data artifacts in the search results being grouped in accordance with their respective types, the displayed data artifacts in the search results within each type being listed in descending order of relevance to the particular subject.

2. The method of claim 1, further comprising:
limiting the search results, in response to a user's selection of a particular data artifact among the displayed search results, to include only those data artifacts in the set of data artifacts associated with the particular subject that are from Web pages containing the particular data artifact.

3. The method of claim 1, further comprising:
excluding from the search results, in response to a user's selection of a particular data artifact among the displayed search results, data artifacts in the set of data artifacts associated with the particular subject that are from Web pages containing the particular data artifact.

4. The method of claim 1, wherein the predetermined set of types includes at least one of a name of a person, a geographic location, an organization, a clipping, an item concerning education, an identifier associated with a manner of electronically contacting a person, a hobby, an interest, a biography, and an item of miscellaneous information.

5. The method of claim 1, wherein the at least one data structure is archived periodically and the search results are retrieved from an archive corresponding to a time period specified in the query.

6. The method of claim 1, wherein retrieving search results from the at least one data structure includes accounting for morphological variations of the particular subject.

7. The method of claim 1, wherein a subject is a person's name.

8. The method of claim 7, further comprising:
inferring that a particular data artifact, other than the particular subject, that is classified as a name of a person is likely to be associated with the particular subject; and
including the particular data artifact in the set of data artifacts associated with the particular subject.

9. The method of claim 1, wherein the set of data artifacts associated with the particular subject further includes a list of unclassified Uniform Resource Locators (URLs) from which the search results were obtained, the URLs in the list of unclassified URLs being presented in descending order of their relevance to the particular subject.

10. The method of claim 1, further comprising:
exporting to a specified network destination at least one data artifact from the search results in response to a request.

11. The method of claim 1, further comprising:
importing a list of subjects to be searched; and
retrieving, for each subject in the list of subjects, search results from the at least one data structure, the search results for each subject in the list of subjects including a set of data artifacts associated with that subject.

12. The method of claim 1, further comprising:
removing a subset of Web pages from the set of Web pages prior to the analyzing, the classifying, and the indexing and organizing.

13. A method for collecting and retrieving information from Web sites, the method comprising:
acquiring a set of Web pages;
for each Web page in the set of Web pages:
analyzing the Web page for data artifacts;
classifying each data artifact on the Web page as one of a predetermined set of types; and
indexing and organizing in at least one data structure each classified data artifact, each indexed and organized data artifact in the at least one data structure being associated with a subject, all indexed and organized data artifacts that are associated with a non-unique subject being associated with a single subject entry;
receiving a query indicating a particular subject to be searched;
retrieving search results from the at least one data structure, the search results including a set of data artifacts associated with the particular subject;
displaying at least some of the search results, the displayed data artifacts in the search results being grouped in accordance with their respective types, the displayed data artifacts in the search results within each type being listed in descending order of relevance to the particular subject;
in response to a user's selection of a particular data artifact among the displayed search results in connection with a first triangulation mode, limiting the search results to include only those data artifacts in the set of data artifacts associated with the particular subject that are from Web pages containing the particular data artifact; and
in response to a user's selection of a particular data artifact among the displayed search results in connection with a second triangulation mode, excluding from the search results data artifacts in the set of data artifacts associated with the particular subject that are from Web pages containing the particular data artifact.

14. A method for collecting information from Web sites, the method comprising:
acquiring a set of Web pages; and
for each Web page in the set of Web pages:
analyzing the Web page for data artifacts;
classifying each data artifact on the Web page as one of a predetermined set of types; and
indexing and organizing in at least one data structure each classified data artifact, each indexed and organized data artifact in the at least one data structure being associated with a subject, all indexed and organized data artifacts that are associated with a non-unique subject being associated with a single subject entry.

15. A method for processing a request for information collected from Web sites, the method comprising:
receiving, from a requesting computer, a query indicating a particular subject to be searched in a data collection stored in at least one data structure, the at least one data structure having been constructed by examining each of a set of Web pages for data artifacts, each data artifact on a given Web page having been classified as one of a predetermined set of types, each classified data artifact having been indexed and organized in the at least one data structure, each indexed and organized data artifact in the at least one data structure having been associated with a subject, all indexed and organized data artifacts that are associated with a non-unique subject being associated with a single subject entry;
retrieving search results from the at least one data structure, the search results including a set of data artifacts associated with the particular subject; and
outputting at least a portion of the search results to the requesting computer.

16. A method for obtaining information collected from Web sites, the method comprising:
submitting a search query indicating a particular subject to be searched in a data collection stored in at least one data structure, the at least one data structure having been constructed by examining each of a set of Web pages for data artifacts, each data artifact on a given Web page having been classified as one of a predetermined set of types, each classified data artifact having been indexed and organized in the at least one data structure, each indexed and organized data artifact in the at least one data structure having been associated with a subject, all indexed and organized data artifacts that are associated with a non-unique subject being associated with a single subject entry; and
receiving search results retrieved from the at least one data structure, the search results including a set of data artifacts associated with the particular subject.

17. A system for collecting and retrieving information from Web sites, the system comprising:
a data acquisition subsystem configured to acquire a set of Web pages;
an inference, classification, and indexing subsystem configured, for each Web page in the set of Web pages, to:
analyze the Web page for data artifacts;
classify each data artifact on the Web page as one of a predetermined set of types; and
index and organize in at least one data structure each classified data artifact, each indexed and organized data artifact in the at least one data structure being associated with a subject, all indexed and organized data artifacts that are associated with a non-unique subject being associated with a single subject entry; and
a search subsystem configured to:
receive a query indicating a particular subject to be searched;
retrieve search results from the at least one data structure, the search results including a set of data artifacts associated with the particular subject; and
display at least some of the search results, the displayed data artifacts in the search results being grouped in accordance with their respective types, the displayed data artifacts in the search results within each type being listed in descending order of relevance to the particular subject.

18. The system of claim 17, wherein the search subsystem is further configured to:
limit the search results, in response to a user's selection of a particular data artifact among the displayed search results, to include only those data artifacts in the set of data artifacts associated with the particular subject that are from Web pages containing the particular data artifact.

19. The system of claim 17, wherein the search subsystem is further configured to:
exclude from the search results, in response to a user's selection of a particular data artifact among the displayed search results, data artifacts in the set of data artifacts associated with the particular subject that are from Web pages containing the particular data artifact.

20. The system of claim 17, wherein the system is configured to archive the at least one data structure periodically and the search subsystem is configured to retrieve the search results from an archive corresponding to a time period specified in the query.

21. The system of claim 17, wherein the search subsystem, in retrieving the search results from the at least one data structure, is configured to account for morphological variations of the particular subject.

22. The system of claim 17, wherein a subject is a person's name.

23. The system of claim 22, wherein the search subsystem is configured to:
infer that a particular data artifact, other than the particular subject, that is classified as a name of a person is likely to be associated with the particular subject; and
include the particular data artifact in the set of data artifacts associated with the particular subject.

24. The system of claim 17, wherein the search subsystem is configured to include, in the search results, a list of unclassified Uniform Resource Locators (URLs) from which the search results were obtained, the search subsystem presenting the URLs in the list of unclassified URLs in descending order of their relevance to the particular subject.

25. The system of claim 17, wherein the search subsystem is configured to export to a specified network destination at least one data artifact from the search results in response to a request.

26. The system of claim 17, wherein the search subsystem is configured to:
import a list of subjects to be searched; and
retrieve, for each subject in the list of subjects, search results from the at least one data structure, the search results for each subject in the list of subjects including a set of data artifacts associated with that subject.

27. The system of claim 17, wherein at least one of the search subsystem and the at least one data structure is distributed over a plurality of servers.

28. The system of claim 17, further comprising:
a set of application programming interfaces enabling a third party to interact with the system by including, within a computer application, a programmatic interface with the system.

29. The system of claim 17, wherein the predetermined set of types includes at least one of a name of a person, a geographic location, an organization, a clipping, an item concerning education, an identifier associated with a manner of electronically contacting a person, a hobby, an interest, a biography, and an item of miscellaneous information.

30. The system of claim 17, further comprising:
a data preparation subsystem configured to remove a subset of Web pages from the set of Web pages before the set of Web pages is processed by the inference, classification, and indexing subsystem.

31. A system for collecting and retrieving information from Web sites, the system comprising:
a data acquisition subsystem configured to acquire a set of Web pages;
an inference, classification, and indexing subsystem configured, for each Web page in the set of Web pages, to:
analyze the Web page for data artifacts;
classify each data artifact on the Web page as one of a predetermined set of types; and
index and organize in at least one data structure each classified data artifact, each indexed and organized data artifact in the at least one data structure being associated with a subject, all indexed and organized data artifacts that are associated with a non-unique subject being associated with a single subject entry; and
a search subsystem configured to:
receive a query indicating a particular subject to be searched;
retrieve search results from the at least one data structure, the search results including a set of data artifacts associated with the particular subject;
display at least some of the search results, the displayed data artifacts in the search results being grouped in accordance with their respective types, the displayed data artifacts in the search results within each type being listed in descending order of relevance to the particular subject;
in response to a user's selection of a particular data artifact among the displayed search results in connection with a first triangulation mode, limit the search results to include only those data artifacts in the set of data artifacts associated with the particular subject that are from Web pages containing the particular data artifact; and
in response to a user's selection of a particular data artifact among the displayed search results in connection with a second triangulation mode, exclude from the search results data artifacts in the set of data artifacts associated with the particular subject that are from Web pages containing the particular data artifact.

32. A system for collecting information from Web sites, the system comprising:
a data acquisition subsystem configured to acquire a set of Web pages; and
an inference, classification, and indexing subsystem configured, for each Web page in the set of Web pages, to:
analyze the Web page for data artifacts;
classify each data artifact on the Web page as one of a predetermined set of types; and
index and organize in at least one data structure each classified data artifact, each indexed and organized data artifact in the at least one data structure being associated with a subject, all indexed and organized data artifacts that are associated with a non-unique subject being associated with a single subject entry.

33. A system for processing a request for information collected from Web sites, the system comprising:
a search subsystem configured to:
receive, from a requesting computer, a query indicating a particular subject to be searched in a data collection stored in at least one data structure, the at least one data structure having been constructed by examining each of a set of Web pages for data artifacts, each data artifact on a given Web page having been classified as one of a predetermined set of types, each classified data artifact having been indexed and organized in the at least one data structure, each indexed and organized data artifact in the at least one data structure having been associated with a subject, all indexed and organized data artifacts that are associated with a non-unique subject being associated with a single subject entry;
retrieve search results from the at least one data structure, the search results including a set of data artifacts associated with the particular subject; and
output at least a portion of the search results to the requesting computer.
